(19) United States
(12) Patent Application Publication
(10) Pub. No.: US 2018/0079028 A1
(43) Pub. Date: Mar. 22, 2018

(54) PLASTIC WOVEN LAMINATE, BAG MADE THEREFROM, METHOD OF MAKING SAME

(71) Applicant: MONDI AG, Wien (AT)

(72) Inventor: Jens Koesters, Wallenhorst (DE)

(21) Appl. No.: 15/708,993

(22) Filed: Sep. 19, 2017

(30) Foreign Application Priority Data
Sep. 21, 2016 (EP) 16189985.1

(51) Int. Cl. B23K 26/00; B65D 30/08; B65D 75/58; B32B 5/02; B32B 27/08; B32B 27/20; B32B 27/32

(52) U.S. Cl. CPC B23K 26/0087; B65D 31/02; B65D 75/58; B32B 5/024; B29C 47/0021; B32B 27/20; B32B 27/32; B32B 2439/06; B32B 27/08

(57) ABSTRACT

A plastic laminate has a plastic fabric formed from woven-together film strips of a plastic containing an additive that increases the absorption of laser radiation and an outer film bonded to the fabric and having at least one first film layer formed of a plastic that is free of laser-absorbing additive.

### FIELD OF THE INVENTION

The present invention relates to a woven plastic laminate. More particularly this invention concerns a bag made from such a laminate and a method of making the laminate.

### BACKGROUND OF THE INVENTION

A known woven plastic laminate for making bags is formed by a fabric of woven-together textile strips and an outer film. The outer film is bonded to the strip fabric, in particular by a polymer layer in an extrusion lamination process.

Woven plastic laminate bags are suitable in particular for big containers having a substantial filling volume and a substantial weight capacity. Very heavy loads can be accommodated due to the individual intersecting strips of the woven fabric. The fact that the film strips are themselves usually oriented also contributes to a particularly high strength. Even in the case of local damage to the woven plastic laminate, tear propagation is prevented by the individual film strips.

Special advantages are achieved due to the combination of the strip fabric with the outer film in that the different mechanical properties complement one another.

The outer film forms a smooth, high-quality surface that may also be provided with a reverse print. In production of the woven plastic laminate, the strip fabric is supplied as a prefabricated intermediate product and is then bonded to the outer film that is usually also prefabricated. It should be noted here that the usual lamination process differs fundamentally from actual film production in large-scale extrusion plants where both the film that forms the film strips and the outer film may be formed by blow extrusion and also by flat film extrusion within the scope of the invention.

Production of the strip fabric as an intermediate product is highly specialized because multiple film strips are formed by extrusion and stretching of a corresponding film and are then woven together. In the production of the woven plastic laminate, therefore the usual freely available standard products are relied on in selecting a strip fabric.

Although the strip fabric is usually formed from a heat-sealable material such as polypropylene, a tight seal is impossible or at any rate is restricted because of the woven structure. Against this background it is known that the opposite outer walls may be formed with a different length in the production of a woven plastic laminate bag in order to then be able to fold over the projecting front wall for closing the woven plastic laminate bag.

As a side fold bag in an embodiment covered by the invention, the separation line is preferably provided with multiple steps, i.e. staggered, which is why the separation line thus described is also referred to in practice as a stagger cut.

A woven plastic laminate as well as a packaging bag formed from it are known from U.S. Pat. Nos. 8,241,194 and 8,540,612, where a sheet of the woven plastic laminate is provided with perforations and a score line in the form of perforations can be formed by punching. To form the perforations, the woven plastic laminate is punched through in some sections, with webs remaining between the punched out holes.

In practice, however, the perforations create problems. First, the perforation webs cannot be cut through easily in view of the strip fabric. There is the risk that fringe may be formed or even individual strips of the strip fabric may be partially pulled out. Furthermore, an unclean and irregularly torn edge is formed along the perforations after the tear strip has been pulled off.

If these disadvantages are to be reduced by reducing the size of the perforation webs, there is then the risk of uncontrolled tearing of the woven plastic laminate at the perforations during processing. One fact to be taken into account here is that in a preferred method of making a packaging bag from this woven plastic laminate, first a woven plastic laminate tubing—optionally with side folds already created—is formed, and then individual tube segments are cut from it. If the perforations are too weak, tearing may occur in particular when forming such a woven plastic laminate tubing with a knife folder or the like.

To avoid these disadvantages, it is known from the above-cited patents that a score line may be created with a laser, and the energy of the laser beam is varied according to a predetermined depth of penetration into the sheeting material while the laser beam is being moved along the path of the intended tear line. When the strip fabric is provided with a plastic layer, in particular a plastic film, perforations can also be created in this additional layer by suitable control of the laser energy so that then the woven plastic laminate sheeting thereby formed can be perforated in the desired manner.

Use of a laser is thus advantageous to form a tear line as described in the cited patents. If only a score line without perforations is to be formed, process management is however extremely difficult in practice. In other words, in the case of a strip fabric, there are usually two intersecting strips one above the other as seen in the thickness direction. However, such a strip fabric cannot be completely water tight when the film strips are interwoven in a wavy pattern, so there are areas at the points of intersection and transitions where there is only one strip or even no strip at all. Then a laser beam can pass through the strip fabric into the underlying polymer layer and create a throughgoing hole. In the case of a tear line, such local perforations are insignificant but a score line cannot readily be formed if it is not to be formed as a tear line but rather as an aid in tearing because then a tight closure of a packaging bag can no longer be ensured due to local defects. One must at least expect a complex process management and/or a substantial effort for quality control.

### OBJECTS OF THE INVENTION It is therefore an object of the present invention to provide an improved plastic woven laminate.

Another object is the provision of such an improved plastic woven laminate that overcomes the above-given disadvantages, in particular in which a score line can be formed easily and reliably.

In addition, a packaging bag made of the woven plastic laminate is to be provided along with a method of making the woven plastic laminate.

### SUMMARY OF THE INVENTION

A plastic laminate has according to the invention a plastic fabric formed from woven-together film strips of a plastic containing an additive that increases the absorption of laser radiation and an outer film bonded to the fabric and having at least one first film layer formed of a plastic that is free of laser-absorbing additive.

According to the invention, the strip fabric used as the intermediate product for production of the woven plastic laminate is not the usual strip fabric but instead is a strip fabric that has already been provided with a laser-absorbing additive during or at the time of its production in order to increase the absorption of laser radiation. This special strip fabric is then combined with the outer film, comprising at least one first film layer that is free of laser-absorbing additive.

Within the scope of the invention, it is thus possible to selectively score and/or cut the strip fabric with a laser, at least the first film layer of the outer film not being cut through or severed and preferably remaining intact. Within the scope of the invention this means that the first film layer of the outer film is not scored by the laser and is not even partially cut and/or notched.

Even if the same or similar materials such as polypropylene are used for the strip fabric on the one hand and the first film layer of the outer film on the other hand, a completely different absorption capacity for laser radiation can be achieved by using the laser-absorbing additive. The strip fabric containing the laser-absorbing additive can then be scored and/or cut very effectively.

The film strips may each be formed in one layer from a monofilm or in multiple layers, in particular from a coextrusion film. In the case of a single layer structure, the film strips always have the laser-absorbing additive through their entire thickness.

In the case of a multilayer structure, however, different embodiments are possible. Thus, for example, in the case of a multilayer design of the individual film strips, the laser-absorbing additive may be present in all film layers and thus may also be distributed throughout the entire film thickness.

According to an alternative embodiment, in the case of a multilayer structure of the film strips, the laser-absorbing additive is present in only one or a portion of the layers of the film strips.

In particular the film strips may each have at least a three-layer structure, and a core layer containing the laser-absorbing additive is between cover layers that are free of the laser-absorbing additive. Such a design is advantageous in particular when the outer layers are thin. Then the core layer is effectively scored by fusion with a laser, while the outer layers are scored to a lesser extent, starting from the same basic polymer substance. For example, a core layer of polypropylene (PP) may be between two cover layers of polypropylene, and only the core layer contains the laser-absorbing additive. Then the cover layers will be thin in comparison with the core layer. The thickness ratio of a cover layer to the core layer may be between 1:4 and 1:20, for example, and the two cover layers are preferably designed to be the same.

In the case of such a multilayer structure, this not only yields the advantage that the amount of laser-absorbing additive can be reduced but instead advantages are also obtained by coextrusion of the at least three-layer structure because deposits of particles on the extrusion nozzle can be prevented by using the cover layers without a laser-absorbing additive. The laser-absorbing additive that is introduced in the form of particles is then no longer at the surface of the film thereby produced in the case of coextrusion.

The preferred material for the film strips is polypropylene, regardless of whether it has a single- or multi-layer structure.

To form the woven plastic laminate, the outer film and the strip fabric may be bonded in various ways, but extrusion lamination is preferred. The outer film and the strip fabric are especially preferably formed by extrusion lamination by at least one intermediate layer connected directly to the strip fabric. Such an extrusion-laminated intermediate layer is introduced between the strip fabric and the outer film in molten form. Then the intermediate layer that is initially still molten can adapt to the incompletely planar structure of the strip fabric and to a certain extent can even penetrate into it, thereby achieving a particularly reliable bond and high composite adhesion when the layer structure thereby formed during the lamination process is exposed to a pressure, in particular in a roller gap.

The laser-absorbing additive may be adapted in particular for the wavelength of an Nd:YAG laser or the wavelength of a CO₂ laser may also be adjusted. Finally, broadband laser-absorbing additives that are suitable for various wavelength ranges are also known. The wavelength of an Nd:YAG laser is usually 1064 μm, or in the case of frequency doubling that is customary in practice, it may be 532 μm in the visible wavelength range. The wavelength of the CO₂ laser that is preferred within the scope of the invention is typically 10.6 μm.

The laser-absorbing additive may preferably contain or consist of talc and/or layered silicates. In particular mixed silicates have proven to be especially advantageous as the laser-absorbing additive, i.e. laser-absorbing substance. For example, lepidolite (Al—K—Li—F silicate), porphyry (Al—K—Fe silicate) or phonolite (Al—K—Na—Ca—Fe silicate) may be used. Kaolinite has proven to be a particularly advantageous additive for absorption of laser radiation. This is a mineral from the class of layered silicates. Kaolinite has the chemical composition Al₄[(OH)₈|Si₄O₁₀]. It is the main component of rock kaolin.

Additional substances that may be considered as the laser-absorbing additive include the following inorganic substances: mica, sericite, chrysotile asbestos, talc (Mg silicate), silica gel (SiO₂), inorganic pigments such as zinc phosphate (Zn₃(PO₄)₂×4H₂O) or calcium chromate (CaCrO₄).

Polymeric substances may also be used as additives to improve the absorption capacity. For example, high-molecular polyethylene glycol, polysaccharides, polydimethylsiloxane, polyacetals such as polyoxymethylene, polycarbonate or polyethylene terephthalate (PET) may be considered for use here.

The laser-absorbing substance is preferably used in an amount of more than 0.1% by weight and less than 50% by weight, preferably between 0.2% by weight and 10% by weight, based on the total mass of the layer containing the substance.

By adding the laser-absorbing additive, it is possible for the strip fabric to be cut through largely or preferably completely when creating a score line such that the first film layer of the outer film remains completely intact. The score line that is formed by extrusion lamination, for example, may end in the intermediate layer directly adjacent to the strip fabric, for example. This intermediate layer then forms a type of buffer and thus also protects the outer film. Within the scope of such an embodiment, the entire outer film then also remains completely intact even in the case of a multilayer structure.

According to a preferred further embodiment of the invention, the first film layer of the outer film and the strip fabric are made of polypropylene (PP). The first film layer may form a surface on the side of the outer film facing away from the strip fabric, for example, such that very good optical and mechanical properties can be achieved with a film layer comprised of biaxially oriented polypropylene (BO-PP). The addition of the laser-absorbing additive in the strip fabric is critical for the different energy input and thus the different scoring of the material by laser radiation in particular in the case of same or similar materials for the first film layer of the outer film as well as the strip fabric.

The outer film may be formed in one layer and then consists only of the first film layer. In addition, a multilayer structure is also possible, in which case all the film layers of the outer film are then preferably free of laser-absorbing additive and also remain intact when the score line is created by a laser.

In addition, there are other possible embodiments within the scope of the invention. For example, it may be provided within the scope of the invention that the outer film is on a first side of the strip fabric, such that an inner film is provided on an opposite second side of the strip fabric—preferably over an intermediate layer formed by extrusion lamination, this inner film having a sealing layer on a surface of the woven plastic laminate on the side opposite the strip fabric.

According to the conceptual correlation, the outer film in the case of a packaging bag formed from the woven plastic laminate forms the outer side while the inner side is formed by the inner film. In this context there is the advantage that in the production of such a packaging bag the inner film is heat-sealable on the sealing layer so that the packaging bag can be shaped comparatively easily and additional function elements such as reusable closing elements, valves or the like can be sealed onto it.

The subject matter of the invention is also a packaging bag formed from the woven plastic laminate described previously, but the above-described inner film is only optional.

Finally the invention also relates to a method of making the woven plastic laminate, and polypropylene containing a laser-absorbing additive is extruded to form a polypropylene film and/or is coextruded with additional layers, such that the polypropylene film is oriented and cut into film strips, the film strips being woven to form a sheet of strip fabric, the sheet of strip fabric being laminated by extrusion lamination with an outer film sheet comprising at least one first film layer that is free of laser-absorbing additive, to form a woven plastic laminate sheet, and wherein a score line is formed by bombardment with a laser such that the strip fabric sheet is at least partially destroyed along the score line.

According to the method described here, a score line may be formed as a tear line such that it extends transversely between opposing edges over the total width of the woven plastic laminate sheet.

Additionally or alternatively, a score line may also be formed in such a way that it extends transversely between opposing edges over only a portion of the width of the woven plastic laminate sheet. Thus a lateral distance remains. Such a score line is typically not provided at a tear line during production but instead as an aid in tearing the package open in use of the bag. A simple straight line may be used to expose a reclosable strip fastener behind it. The score line may also especially preferably be self-contained in the form of a frame in order to be able to remove a segment bordered by the score line to form an opening and/or to expose a reclosable strip fastener.

The score line is formed by a laser, and the use of a CO₂ laser is preferred.

### BRIEF DESCRIPTION OF THE DRAWING

The above and other objects, features, and advantages will become more readily apparent from the following description, reference being made to the accompanying drawing in which:

FIG. 1 is a perspective schematic sectional view of a woven plastic laminate for bags;

FIG. 2 is a section through a laminate according to the invention with a score line;

FIG. 3 is a view like FIG. 2 of an alternative embodiment of the invention;

FIG. 4 is a view of a woven plastic laminate sheet to form a side fold bag with different score lines; and

FIG. 5 shows an unfilled flat side fold bag according to the invention.

### SPECIFIC DESCRIPTION OF THE INVENTION

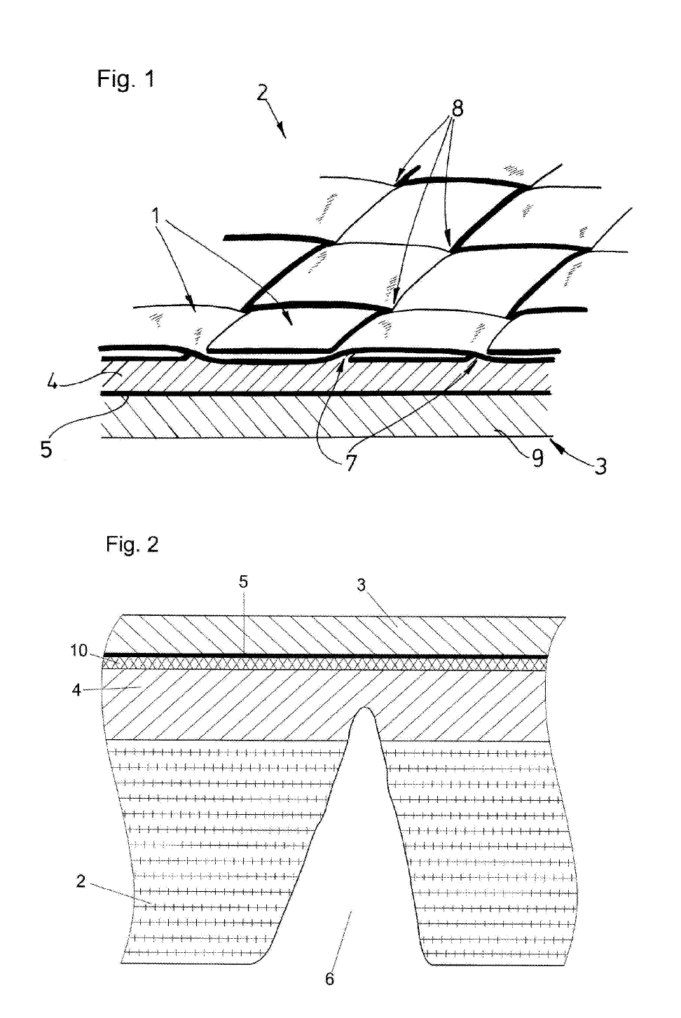

As seen in FIG. 1 a woven plastic laminate for woven plastic laminate bags is formed of a strip fabric 2 formed from intersecting film strips 1 and an outer film 3. The strip fabric 2 and the outer film 3 laminated together by extrusion between them of an intermediate bonding layer 4 that directly engages both the strip fabric 2 and the outer film 3. As shown in FIG. 2, the outer film 3 is provided on its back face in contact with the intermediate layer 4 with an imprint 5 visible through the at least partially transparent outer film 3.

The individual film strips 1 forming the strip fabric 2 are made of oriented polypropylene (O-PP) to give the laminate a particularly high strength. Even in the event of local damage to the woven plastic laminate, tear propagation is prevented by the individual film strips 1.

Due to the combination with the outer film 3, the result is especially advantageous properties of the woven plastic laminate. The outer film 3 forms a smooth high-quality surface with the imprint 5 being optimally protected. Furthermore despite the woven structure of the strip fabric 2, an imperviousness of the woven plastic laminate is ensured by the outer film 3.

In practice there is the need when making woven plastic laminate bags to provide the woven plastic laminate with at least one score line 6 (see FIG. 2 below) in order to be able to tear the woven plastic laminate in a controlled manner in the production process or to expose an opening through which the bag's contents can be accessed or poured.

The problem is that this strip fabric 2 has an especially great stability. Furthermore as seen in FIG. 1 the strip fabric 2 is not flat. Instead the individual film strips 1 are interwoven so that there are local differences in layering. Whereas two film strips 1 are one above the other over most of the service area in the thickness direction, sometimes there is only one or even no layer of the strip fabric 2 at the transitions 7 and at corners or points of intersection 8 between the strips 1.

Whereas the woven plastic laminate can easily be punched through or cut completely, partial punching or cutting of the woven plastic laminate to produce a score line 6 not pass all the way through the workpiece is difficult. The score line 6 must be created in such a way that preferably the entire strip fabric 2 is severed or at least scored uniformly without excessive damage to the outer film 3 at the transitions 7 and points of intersection 8.

Against this background, according to the invention the strips 1 of the fabric 2 contain a laser-absorbing additive that increases the absorption of laser radiation whereas the outer film 3 includes at least one first film layer 9 that is free of such laser-absorbing additives. If the woven plastic laminate illustrated in FIG. 1 is then impinged with a laser beam of the appropriate wavelength, then only the strip fabric 2 is scored and preferably severed selectively without any damage at all to the first film layer 9 of the outer film 3. In particular, with regard to the creation of the score line, there is also no significant difference whether two layers of the strip fabric 2 are present locally or whether only one film strip 1 or no film strip 1 at all is present at a transition 7 or at a point of intersection 8.

According to a preferred embodiment of the invention, the woven plastic laminate is formed of polypropylene. The outer film 3 may consist only of the first film layer 9 of, for example, biaxially oriented polypropylene (BO-PP). For example, the layer thickness of the outer film may be between 15 and 80 μm, and a comparatively low thickness of 18 μm, for example, is sufficient in particular in forming the outer film 3 made of BO-PP.

The intermediate bonding layer introduced in the extrusion lamination may also be formed of polypropylene, for example, and will typically have a thickness between 15 μm and 45 μm. Alternatively, for better adaptation to the materials used, extrusion lamination may be performed by coextrusion, in which case then the total thickness of the jointly extruded layers may readily also be within the stated range of 15 μm to 40 μm. The resultant typical surface weight or grammage of the strip fabric 2 is between 50 and 70 g/m².

FIG. 2 shows a woven plastic laminate with the strip fabric 2 and an outer film 3 provided with the back-face or reverse imprint 5 turned toward the strip fabric 2. In FIG. 2, extrusion lamination is performed by coextrusion, and the intermediate layer 4 is connected directly to the strip fabric 2 with an additional bonding layer 10 provided over the printing on the back or inner face of the outer film 3. The bonding layer 10 may be formed from a terpolymer as the adhesive, for example.

FIG. 2 shows a preferred embodiment of the invention, where a score line 6 is created by a laser. The score line 6 can easily be created in this strip fabric 2 because of the laser-absorbing additive in the film strips 1. The directly adjacent intermediate layer 4 is also heated by thermal heating of the strip fabric 2 and is easily notched. However, the score line 6 ends within the intermediate layer 4, that is does not cut all the way through it.

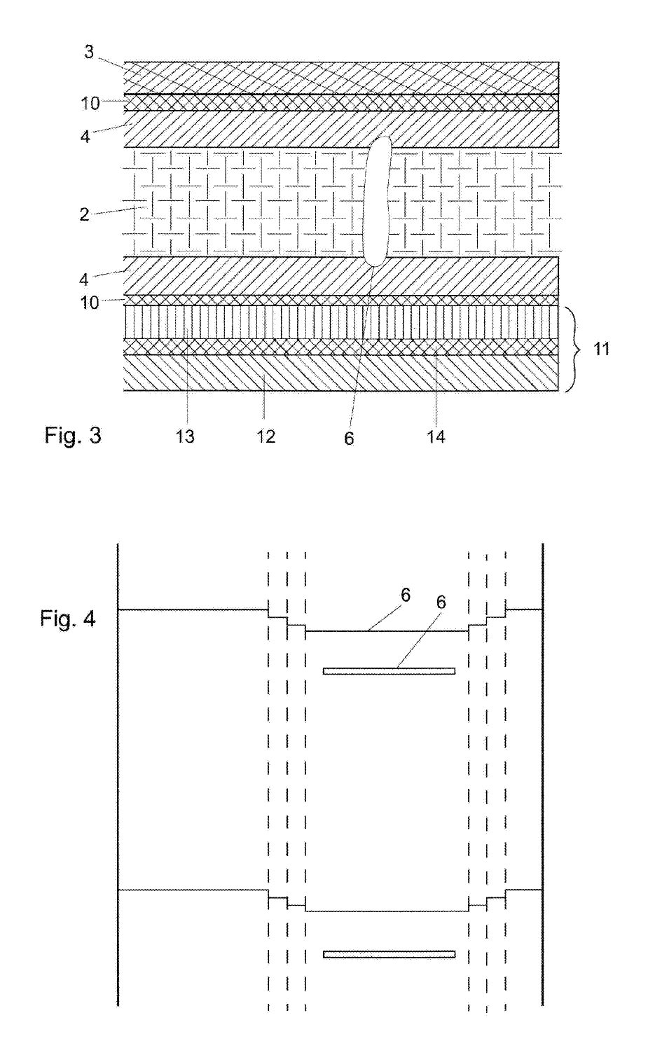

FIG. 3 shows an alternative embodiment of the woven plastic laminate, in which a multilayer inner film 11 that includes a sealing layer 12 is provided in addition to an outer film 3. The sealing layer 12 is on the outer face of the inner film 11 opposite the strip fabric 2 and forms an outer surface of the woven plastic laminate. In the illustrated embodiment, the inner film 11 includes not only the sealing layer 12 but also a barrier layer 13 that may be made of EVOH or polyamide (PA), for example. The barrier layer 13 is connected to the sealing layer 12 by an adhesive layer 14, such that the inner film may be formed by coextrusion, in particular blow film coextrusion.

To join the outer film 3 on the one hand and the inner film 11 on the other hand to the strip fabric 2, extrusion lamination by coextrusion is provided. First an intermediate layer 4 and then a bonding layer 10 are connected on both sides of the strip fabric 2.

FIG. 3 additionally shows a score line 6 that sores the strip fabric 2 and preferably even severs or cuts all the way through it. The score line 6 ends in the intermediate layers 4 sandwiching the fabric 2. Depending on the material, however, individual layers may also be furnished with a laser-absorbing additive if the woven plastic laminate is no longer tearable to a sufficient extent. At least the barrier layer 13 based on EVOH or PA has a greater absorption capacity in comparison with a conventional polyolefin such as polypropylene in particular at the wavelength of a CO₂ laser so that the barrier layer 13 as well is also scored by a corresponding bombardment at least to a certain extent.

According to FIG. 4, the score line 6 is provided only in the strip fabric 2 and extends only into the intermediate layers 4 directly adjacent to it.

Within the scope of the invention, it is important that the outer film 3 includes at least the one first film layer 9 that is free of the laser-absorbing additive and that remains intact when impinged by a laser beam.

However, the possibility cannot be ruled out that a film layer is severed over the entire inner film 11 when the inner film 11 is merely optional within the scope of the invention.

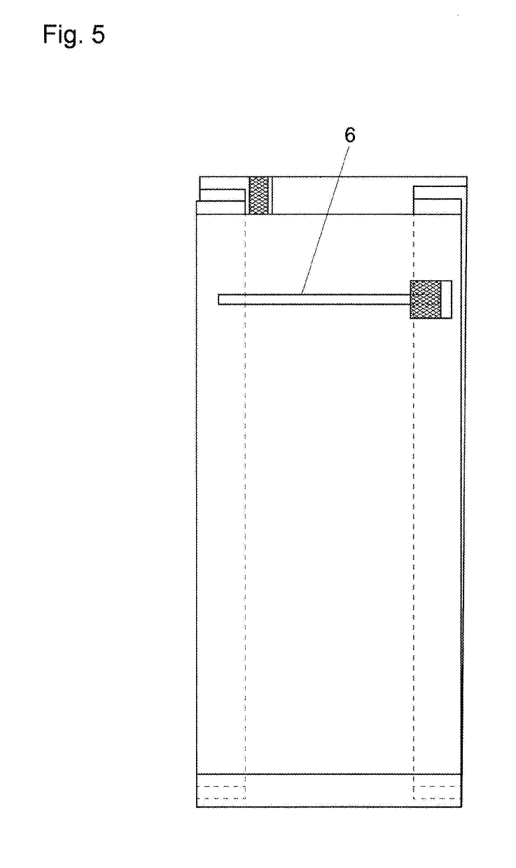

FIG. 4 shows as an example a woven plastic laminate sheet used to subsequently produce a side-fold tubing from which individual blanks of side-fold bags can then be cut (cf. FIG. 5). In this context, FIG. 4 illustrates that different types of score lines 6 can be formed. Whereas one type of score line 6 extends over the entire width of the woven plastic laminate sheet to form a graduated tear line allowing individual bags to be separated from one another, a second type of score line 6 extends along the transverse direction between the opposing edges of the woven plastic laminate sheet to be able to form an opening in a packaging bag. In concrete terms, the corresponding score line 6 borders a finished area that can be cut out of the packaging bag and behind that there may be reclosable strip fastener, for example.

FIG. 5 shows, purely as an example, a flat packaging bag that is formed of the woven plastic laminate according to FIG. 4 and has not yet been filled, individual pieces being torn away along the score lines provided as tear lines after folding and closing the bag at the circumference

I claim:

1. A plastic laminate comprising:
a plastic fabric formed from woven-together film strips of a plastic containing an additive that increases the absorption of laser radiation; and
an outer film bonded to the fabric and having at least one first film layer formed of a plastic that is free of laser-absorbing additive.

2. The plastic laminate defined in claim 1, wherein the film strips contain the laser-absorbing additive over their total thickness.

3. The plastic laminate defined in claim 1, wherein the film strips each have a multilayer structure, the laser-absorbing additive being in only some of the layers of the film strips.

4. The plastic laminate defined in claim 3, wherein each of the film strips is comprised of at least:
a core layer containing the laser-absorbing additive; and
two outer cover layers that are free of the laser-absorbing additive and that sandwich the core layer.

5. The plastic laminate defined in claim 4, wherein the strip fabric is severed completely along a score line and one of the cover layers is intact.

6. The plastic laminate defined in claim 1, further comprising between the outer film and the strip fabric:
an extrusion laminated intermediate layer directly connected to the strip fabric between same and the outer layer.

7. The plastic laminate defined in claim 6, wherein a score line completely severs the strip fabric and ends in the intermediate layer.

8. The plastic laminate defined in claim 1, wherein the one first film layer and the strip fabric are formed from polypropylene.

9. The plastic laminate defined in claim 1, wherein the outer film is on one face of the strip fabric, the laminate further comprising:
an inner film has a sealing layer on its side opposite the strip fabric on ab opposite second face of the strip fabric.

10. The plastic laminate defined in claim 1, wherein the laser-absorbing additive contains talc or layered silicates.

11. A packaging bag of the woven plastic laminate according to claim 1, wherein the outer film is on an outer surface of the bag.

12. A method of making a woven plastic laminate comprising the steps of:
polypropylene containing a laser-absorbing additive is extruded to form a polypropylene film;
orienting the polypropylene film and cutting it into film strips;
weaving the film strips to form a strip fabric sheet;
laminating the strip fabric sheet by extrusion with an outer film sheet comprising at least one first film layer that is free of laser-absorbing additive to form a woven plastic laminate sheet; and
forming a score line by radiation using a laser such that the strip fabric sheet is at least partially destroyed along the score line.

13. The method defined in claim 12, wherein the score line is formed as a tear line such that it extends transversely between opposing edges over the entire width of the woven plastic laminate sheet.

14. The method defined in claim 12, wherein the score line is formed to extend transversely between opposing edges only over a portion of a width of the woven plastic laminate sheet.

15. The method defined in claim 12, wherein the score line is formed with a CO₂ laser.
